(19) United States
(12) Patent Application Publication
(10) Pub. No.: US 2010/0076794 A1
(43) Pub. Date: Mar. 25, 2010

(54) Systems For Valuating and Tracking Items of Property

(76) Inventor: William Seippel, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/560,666

(22) Filed: Sep. 16, 2009

Related U.S. Application Data
(60) Provisional application No. 61/097,409, filed on Sep. 16, 2008.

(51) Int. Cl. G06Q 30/00; G06F 19/00; G06Q 40/00; G06Q 10/00

(52) U.S. Cl. 705/4; 235/385; 705/27; 705/28; 705/306

(57) ABSTRACT

Systems, methods, and computer program products are provided for tracking and providing information relating to items of tangible personal property. For example, in one embodiment, a property management system is adapted to (a) periodically estimate the value of one or more items of tangible personal property based on data regarding the sale of similar items of tangible personal property and (b) track the value of one or more items of tangible personal property. The property management system may also be used for purposes other than estimating the value of a particular item. For example, the information may be used to help an owner locate a lost or stolen item of tangible personal property.

### CROSS-REFERENCE TO RELATED APPLICATIONS

This application claims priority to U.S. Provisional Application No. 61/097,409, filed Sep. 16, 2008, which is hereby incorporated herein in its entirety by reference.

### BACKGROUND

Collecting has become a hobby and passion for a great number of people. For example, it is very common for people to collect art, books, clocks, coins, dolls, figurines, flags, furniture, glassware, memorabilia, movies (videos, DVDs, and the like), music, posters, prints, stamps, toys, and watches. Collecting such items is not just something done for enjoyment, it is also done as a means of investing. In other words, in the same way that one would acquire equity stock or land, many collectors accumulate collectables and other items of tangible personal property anticipating that the value of these items will increase over time.

Irrespective of the motive underlying the acquisition of items of tangible personal property, there exists a need to provide a comprehensive system (e.g., a computer system) that allows individuals to track the value and location of these items and similar items.

### BRIEF DESCRIPTION OF THE SEVERAL VIEWS OF THE DRAWINGS

FIG. 1 shows a property management system according to a particular embodiment of the invention.

FIG. 2 shows an exemplary embodiment of a property management system that is connected via a network to exemplary network entities.

FIG. 3 shows an exemplary item of tangible personal property.

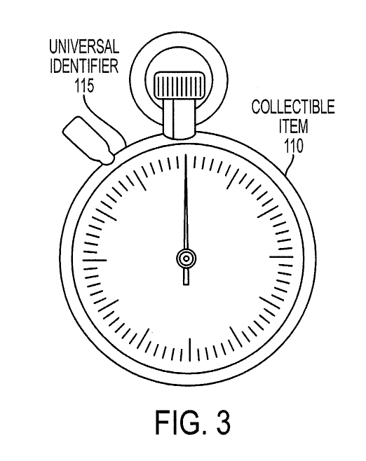

FIG. 4 shows an exemplary relationship structure of a portfolio, sub-portfolios, and particular items of tangible personal property.

FIG. 5 shows a graphical representation, generated by an exemplary property management system, of the change in value of a particular item over time.

FIG. 6 shows a graphical representation, generated by an exemplary property management system, of the change in value of a particular sub-portfolio of items over time.

FIG. 7 shows a graphical representation, generated by an exemplary property management system, of the change in value of a particular portfolio of items over time.

FIG. 8 shows exemplary information received from a sale price information provider.

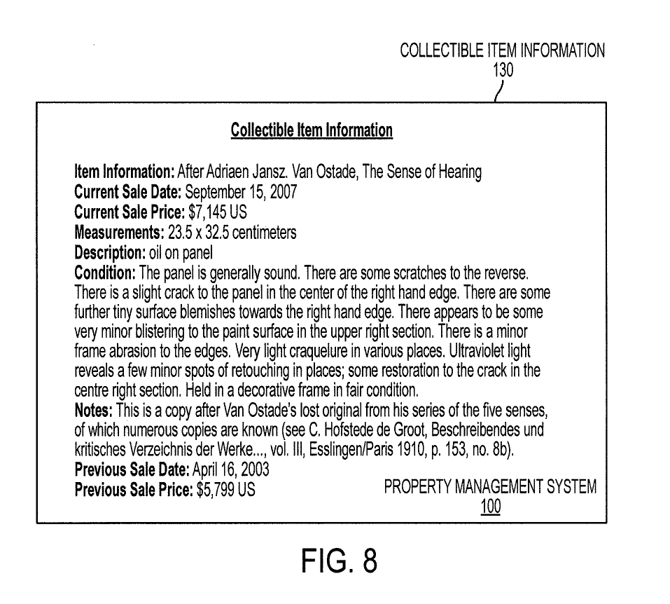

### DETAILED DESCRIPTION

The present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As should be appreciated from the present disclosure, exemplary embodiments of the invention may be implemented as methods, apparatuses, systems, or computer program products. Accordingly, particular embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the exemplary embodiments may take the form of web-implemented computer software. Any suitable computer-readable storage medium may be utilized including hard disks, CD-ROMs, optical storage devices, or magnetic storage devices.

Exemplary embodiments of the invention are described below with reference to block diagrams and flowchart illustrations of methods, apparatuses, systems, and computer program products. It should be understood that each block of the block diagrams and flowchart illustrations, and combinations of blocks in the block diagrams and flowchart illustrations, respectively, may be implemented by computer program instructions, e.g., a logical steps. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support various combinations for performing the specified functions, combinations of steps for performing the specified functions and program instructions for performing the specified functions. It should also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

### Exemplary System Architecture

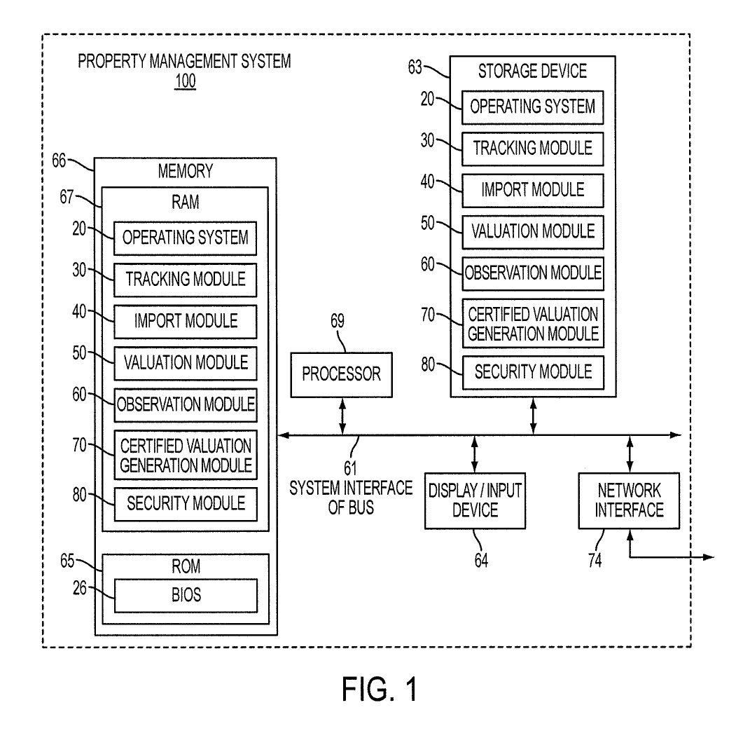

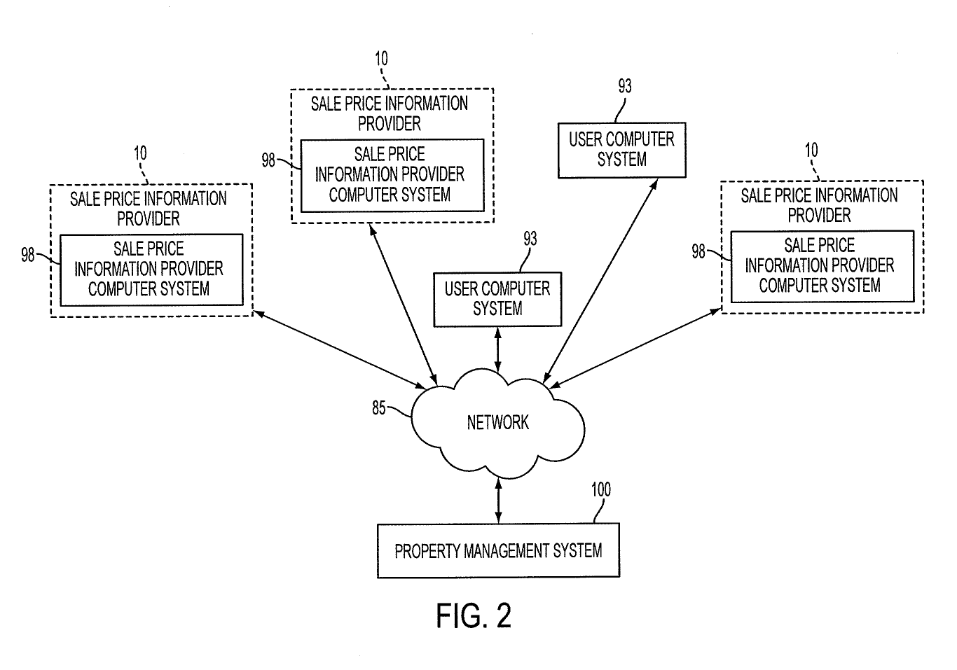

FIG. 1 shows a property management system 100 according to an exemplary embodiment. In particular embodiments, a property management system 100 may comprise, for example, any computer, mainframe, desktop, database, notebook or laptop, gateway, router, server, hub, switch, repeater, network entity, or any other processing device configured to perform the functions described herein. As may be understood from FIGS. 1 and 2, in particular embodiments, the property management system 100 is connected to one or more networks 85 (e.g., connected via a LAN, MAN, WAN, the Internet, or private network) to communicate with other computing entities, such as a user computer system 93 or a sale price information provider computer system 98. This communication is typically executed via the network interface 74 using a wired data transmission protocol, such as X.25, ISDN, DSL, PIP, Ethernet, ATM, frame relay, DOCSIS, or any other wired transmission protocol. Similarly, the property management system 100 may be configured to communicate via wireless external communication networks using a wireless protocol such as 802.11, 802.15.4, standard 3G, CDMA2000 1x EV-DO, GPRS, W-CDMA, or any other wireless protocol.

As also indicated in FIG. 1, the property management system 100 may implement the functionality described herein via one or more modules, e.g., a tracking module 30, an import module 40, a valuation module 50, an observation module 60, a certified valuation generation module 70, and/or a security module 80. As will be recognized, the architectures described are exemplary and not limiting to the various embodiments. For example, the various modules may, in various embodiments, be implemented as separate systems. Thus, in one embodiment, the property management system 100 may be embodied in a distributed computing system. That is, the property management system 100 may be located remotely from various systems implementing the functionality of each respective module. Alternatively, in another embodiment, the various systems implementing the functionality of each respective module may reside on the same computer system as the property management system 100.

In the embodiment shown in FIG. 1, the property management system 100 includes a processor 69 that communicates with other elements within the property management system 100 via a system interface or bus 61. Also included in the property management system 100 is a display device/input device 64 for receiving and displaying data. This display device/input device 64 may be, for example, a keyboard or pointing device that is used in combination with a monitor. The property management system 100 further includes memory 66, which may include both read only memory (ROM) 65 and random access memory (RAM) 67. The property management system's ROM 65 is used to store a basic input/output system 26 (BIOS), containing the basic routines that help to transfer information between elements within the property management system 100.

In addition, the property management system 100 may include a storage device 63, such as a hard disk drive, a floppy disk drive, a CD ROM drive, or optical disk drive, for storing information on various computer-readable media, such as a hard disk, a removable magnetic disk, or a CD-ROM disk. As will be appreciated, each of these storage devices 63 may be connected to the system bus 61 by an appropriate interface. The storage devices 63 and their associated computer-readable media provide nonvolatile storage. The computer-readable media described above may, in various embodiments, be replaced by any other type of computer-readable media, e.g., magnetic cassettes, flash memory cards, digital video disks, and Bernoulli cartridges. A number of program modules may be stored by the various storage devices and within RAM 67. Such program modules may include a tracking module 30, an import module 40, a valuation module 50, an observation module 60, a certified valuation generation module 70, and a security module 80. The various modules control certain aspects of the operation of the property management system 100, with the assistance of the processor 69 and operating system 20.

### General Overview of System

In general, exemplary embodiments described herein provide apparatuses, network entities, systems, methods, and computer program products for tracking and providing information relating to items of tangible personal property. Items of tangible personal property may include, for example: antiques, art, autographed items, automobiles, bicycles, books, bottles, clocks, coins, comic books, currency, dolls, doll houses, electronics, eyeglasses, figures, figurines, flags, furniture, games, gemstones, glassware, jewelry, key chains, knives, lamps, lighters, magazines, memorabilia, movies (VHS tapes, DVDs, and the like), music, music boxes, musical instruments, newspapers, paper, photographic images, porcelain, posters, postcards, prints, quilts, souvenirs, stamps, tools, toys, trading cards, umbrellas, and watches. The term “item of tangible personal property” is not intended to include securities (e.g., stocks or bonds) or real property.

In particular embodiments, the property management system 100 is adapted to track the value of one or more items of tangible personal property owned by an individual or entity. In various embodiments, the property management system 100 is adapted to provide this functionality for a plurality of individuals and/or entities.

In various embodiments, the property management system 100 is adapted to periodically determine the value of one or more items of tangible personal property based on data regarding the past sale of similar items of tangible personal property (or on past sales of the item at issue). In a preferred embodiment, such past sale data is imported into the property management system 100 on an ongoing basis to ensure that the information used to assess the value of a particular item is current.

For example, if the item to be evaluated is a mint condition 12″ Luke Skywalker action figure, the property management system 100 may periodically (e.g., automatically or upon manual request by a user) estimate the value of the action figure based on past (preferably recent) sales of the same or similar action figures (e.g., other 12″ Luke Skywalker action figures that are in mint condition). In preferred embodiments, the property management system 100 may access past item sale information from a large database of item information that may be stored in the property management system's memory, or stored remotely from the property management system 100.

In some cases, this database of items may be populated with information received from one or more sale price information providers 10, which may include, for example, auction houses, or on-line auction services (e.g., eBay) that sell items of tangible personal property on a regular basis. In particular embodiments, a provider of the property management system 100 may enter contractual agreements with one or more sale price information providers 10 under which the sale price information providers 10 provide item sale information (e.g., from the sale price information provider's recent auctions) for inclusion in the property management system's database of sale price information. It should be understood that, in various embodiments, the relationship between the entity providing the property management system and each sale price information provider 10 may be an informal relationship, rather than a formal contractual relationship.

In particular embodiments of the invention, the sale price information providers 10 provide the following information for each particular item for inclusion in the item sale information database: (1) description; (2) sale price; (3) date of sale; (4) location of sale; (5) buyer; (6) seller; (7) entity facilitating the sale of the item (e.g., the auction house that facilitated the sale of the item); (8) general condition (e.g., mint, excellent, good, fair, poor); and/or (9) detailed condition (e.g., “The paint and ground layers appear to be well-adhered to the canvas. There is no evidence of active insecurity such as cleaving, tenting, flaking, or associated loss”). In particular embodiments, the sale price information provider 10 may also provide one or more pictures of the item (e.g., in the condition in which the item was sold) for inclusion in the item sale information database.

In various embodiments, the property management system's database of sale price information may be used for purposes other than estimating the current market value of a particular item. For example, the information may be used to help the owner of a lost or stolen item locate the item.

### More Detailed Description of System

Systems and methods according to various particular embodiments of the invention will now be described in greater detail. As part of this more detailed description, a taxonomy structure according to further embodiments of the invention will first be described. This taxonomy structure is used, in particular embodiments, to organize information within a database of item sale information, and to match a particular item within an individual's portfolio with similar items. This may be useful in identifying data for use in assessing the value of the particular item.

The discussion of taxonomy structures is followed by exemplary discussions of: (1) how information regarding the sale of various items is imported into a property management system's database; (2) how a user establishes portfolios of items; (3) how the property management system 100 uses information from the database to assess both the value of items within the user's portfolio of items and the value of the portfolios themselves; (4) how the property management system 100 reports item and portfolio values to a user; (5) how the property management system 100 generates portfolio and item value alerts; and (6) other functionality of the property management system 100, such as the property management system's 100 ability to help a user identify lost items and to develop certified valuations of particular items.

### A. Taxonomy Structure

In various embodiments, a taxonomy structure is created for classifying the various items stored within the property management system's database and/or within each individual user's portfolios of items. As will be understood by one skilled in the field of taxonomies, in various embodiments, a suitable taxonomy structure is an organizational structure for categorizing items into particular classes and/or subclasses of items. However, in a particular embodiment of the invention, each item is: (1) assigned to a particular taxonomy class and/or one or more subclasses; and (2) assigned a particular unique item identifier that reflects (a) the taxonomy classes and subclasses to which the item corresponds, (b) the identification of the item itself, and (c) the condition of the item.

### B. Population of Database

As noted above, the property management system's database of item information may be populated with information, received from one or more auction houses, regarding the sale of items at the auction houses. In a particular embodiment, when importing this type of information for a particular item into the property management system's database, the property management system 100 (or an individual) first determines the proper class/subclass for the item within the property management system's 100 taxonomy structure. The property management system 100 (or individual) then uses both this information and the general condition information for the item (e.g., whether the item is in mint, excellent, good, fair, or poor condition) to determine a particular item identifier to associate with the item. The property management system 100 then associates the identified class/subclass and item identifier information with the item information and saves the class/subclass, item identifier, and item sale information into the property management system's database.

For example, if the property management system 100 were to receive information from an auction house indicating that a 1978 12″ Luke Skywalker action figure in mint condition recently sold for $79.99, the property management system 100 might determine that: (1) the proper class for the item is “Toys”; (2) the first-level subclass for the item is “Star Wars Collectables”; (3) the second-level subclass for the item is “Action Figures”; (4) the third-level subclass for the item is “Vintage”; (5) the fourth-level subclass for the item is “Luke Skywalker”; and (6) that the unique item identifier of a 1978 12″ Luke Skywalker action figure in mint condition is “781297574.” In this example, the number “4” at the end of the item identifier indicates that the item is in “mint” condition. As a point of comparison, in this example, the item identifier for the same item in “Good” condition may be “781297572” (here, the item identifier is the same as the mint condition version of the item, except that the last number has been changed to a “2” to indicate that the item is only in “Good” condition).

It should be understood that, if a class, subclass, and/or unique item identifier does not exist for a particular item within the property management system's 100 hierarchy, a new class, subclass, and/or unique identifier may be created for the item. This may either be done automatically by the property management system 100, or manually by a human service agent associated with the property management system 100.

As noted above, the database of items may be populated with information received from one or more sale price information providers 10, which may include, for example, auction houses, or on-line auction services (e.g., eBay) that sell items of tangible personal property on a regular basis. In particular embodiments, a provider of the property management system 100 may enter contractual agreements with one or more sale price information providers 10 under which the sale price information providers 10 provide item sale information (e.g., from the sale price information provider's recent auctions) to the provider for inclusion in the property management system's database of sale price information.

### C. Setup of User Portfolios

In various embodiments, the property management system 100 is configured to allow a user to establish one or more portfolios (and/or sub-portfolios) of items, and to save these portfolios of items into memory associated with the property management system 100. In particular embodiments, the structures of each user's portfolios/sub-portfolios may correspond generally to the structure of the property management system's 100 taxonomy structure. However, in other embodiments, the user may customize their portfolios in any manner that they wish.

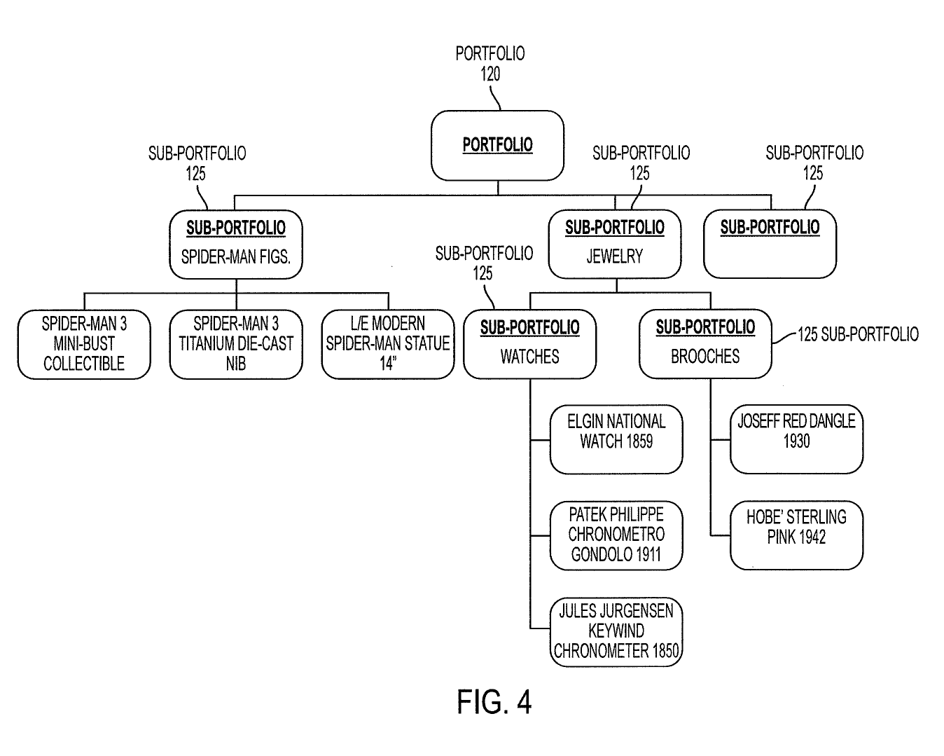

To begin using the property management system 100, a user typically registers with a website providing the functionality described herein (e.g., via a connection to the property management system 100). After registering, the user may create a portfolio 120 of items. As shown in FIG. 4, the term “portfolio” may be used to refer to a group of items of tangible personal property (although a portfolio 120 may be comprised of a single item of tangible personal property). In some circumstances, all or substantially all of an individual or entity's items of tangible personal property that are to be tracked via the property management system 100 are within a single “portfolio” 120. However, a single individual or entity may instead choose to have multiple portfolios of items.

In particular embodiments, a portfolio 120 may further comprise one or more sub-portfolios 125, which may comprise other sub-portfolios 125 and/or items of tangible personal property. The hierarchical relationship between the structures systematically arranges the items of tangible personal property 110 into groups or categories according to established criteria. For instance, as shown in FIG. 4, a user may have, within their overall portfolio, a first sub-portfolio of “toys.” Within the toys sub-portfolio, they may have a second sub-portfolio of “Action Figures.” Furthermore, within the “Action Figures” sub-portfolio, they may have a third sub-portfolio of “Spider Man” Figurines. The Spider Man figurine sub-portfolio may include one or more Spider Man Figurines such as, a Spider-Man 3 Mini-Bust Collectible, and a Spider-Man 3 Titanium Die-Cast NIB.

In particular embodiments, associating the items of tangible personal property in such a structured way facilitates tracking the value of portfolios 120, sub-portfolios 125, and individual items of tangible personal property.

### D. Valuation of Items of Personal Property

In various embodiments, the property management system 100 is adapted for automatically assessing (e.g., estimating) the value of the various items of tangible personal property within a particular individual's portfolio. In particular embodiments, the property management system 100 is configured to estimate the value of a particular item of tangible personal property based on data regarding the past sale of similar items of tangible personal property (or on past sales of the particular item at issue). As noted above, in a preferred embodiment, such past sale data is imported into the property management system 100 on an ongoing basis to ensure that the information used to evaluate the value of a particular item is current.

In particular embodiments, to assess the value of a particular item, the property management system 100 searches the property management system's 100 item sale information database to determine whether the database includes data regarding the past sale of items of the same type and condition as the particular item (e.g., using condition identifiers or codes). If the property management system 100 identifies data regarding the past sale of a sufficient number of items (e.g., more than a predetermined number of such items) of the same type and condition as the item at issue, the property management system 100 estimates a value of the item using any suitable statistical technique. For example, in a particular embodiment, the property management system 100 would estimate a value of the item by calculating an average sale price of any items of the same type and condition as the item at issue that are within the property management system's 100 past sale information database. Calculating the average may include excluding outlying sale amounts

If the property management system 100 does not include data regarding the past sale of a sufficient number of items of the same type and condition as the item at issue, the property management system 100 determines whether the database includes data regarding the past sale of items of the same type and similar condition as the item at issue. The property management system 100 may then adjust the sale price of each previously sold item to account for the difference in condition between the previously sold item and the item at issue. For example, if the item to be valued is a 1978 12″ Luke Skywalker action figure that is in good condition, and the property management system's database includes information regarding the past sale of four 1978 12″ Luke Skywalker action figures that were in excellent condition when sold, the property management system 100 may adjust the sale price of the excellent-condition action figures to estimate what the price of the action figures would have been if they would have been in only good condition. For example, the property management system 100 may multiply the sale price of the excellent condition action figures by a quality adjustment factor, such as 0.7, to account for differences in condition. The property management system 100 may then use the modified sales data to estimate the value of a 1978 12″ Luke Skywalker action figure that is in good condition (e.g., by averaging the adjusted sales prices of the four excellent-condition Luke Skywalker action figures that are within the property management system's database.)

It should be understood, in light of this disclosure, that similar techniques may be used to adjust past sale data for various items to account for other differences between the item to be valued and similar items for which past sale data is stored in the property management system's database. Such differences may include, for example: (1) the recency of the previous sale information; (2) the size of the item at issue; (3) the model number of the item at issue; and/or (4) any other differences.

The property management system 100 may use similar techniques to estimate the value of one or more of the property management system's 100 portfolios or sub-portfolios. This property management system 100 may do this, for example, by first calculating the value of each item in each respective portfolio or sub-portfolio individually, and then summing these values to determine the overall value of each respective portfolio or sub-portfolio.

The property management system 100 may also be configured to automatically re-estimate the value of an individual's portfolios 120, sub-portfolios 125, and/or individual items on a periodic basis. For example, in particular embodiments, the property management system 100 may be adapted to re-estimate the value an individual's portfolios 120, sub-portfolios 125, and/or individual items according to a schedule specified by a user (e.g., on the first day of every month, every financial quarter, or every year).

The property management system 100 may use such techniques to determine if an item meets or exceeds a predetermined threshold value. For example, the property management system 100 may receive a request from a user desiring to know whether an item is of substantial value (e.g., whether the item is a collectible). Thus, the property management system 100 may identify the item and estimate its value. If the value of the item meets or exceeds the predetermined threshold value, the property management system 100 may cause display of information indicating that the item of tangible personal property has reached or exceeded the predetermined threshold value (e.g., indicate that the item is a collectible). Otherwise, the property management system 100 may cause display of information indicating that the item of tangible personal property has not reached or exceeded the predetermined threshold value (e.g., indicate that the item is not a collectible).

### E. Reporting of Item and Portfolio Values

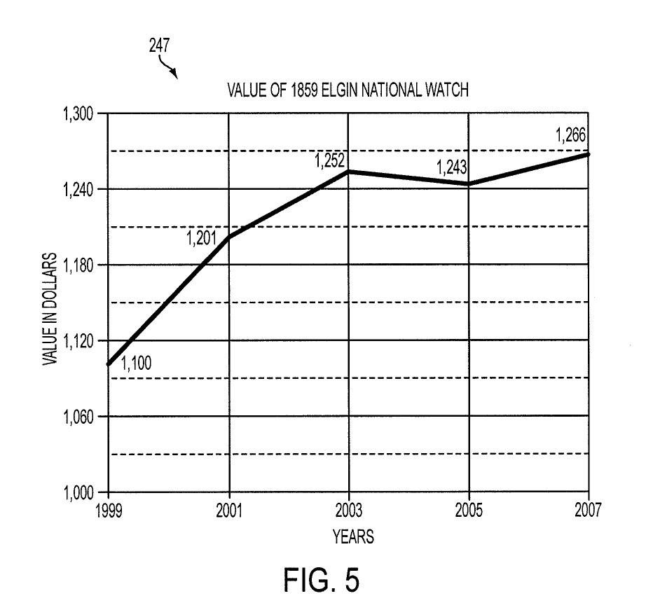

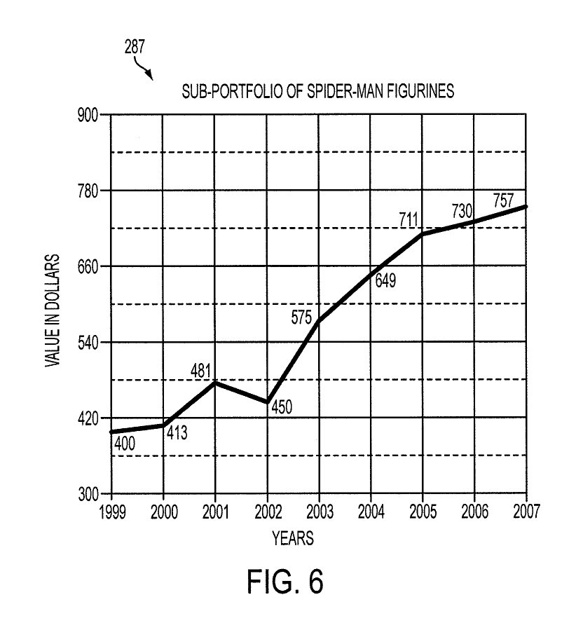

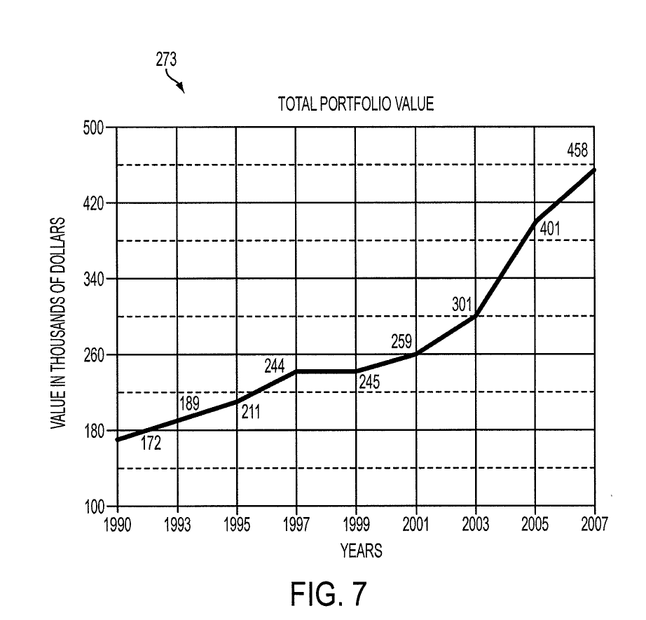

As shown in FIGS. 5-7, the property management system 100 may be configured to report a history of the values of an individual's portfolios, sub-portfolios, and/or individual items over time. For example, the property management system 100 may be adapted to generate and display a graph (or other suitable graphical representation) showing the changes in value of a particular portfolio, sub-portfolio, or particular item over a specified period of time (e.g., over an observation period). As one particular example shown in FIG. 6, the property management system 100 may be adapted to display the year-to-year changes of a particular sub-portfolio of items (e.g., all of an individual's Spider-Man figurines) over the course of a specified eight year period.

### F. Generating Portfolio and Item Value Alerts

The property management system 100 may also be adapted to generate an alert in response to estimating that the value of a particular portfolio, sub-portfolio, or item has reached or exceeded a predetermined threshold value. This may occur, for example, when the property management system 100 automatically re-estimates the value of a particular item according to a specified schedule as discussed above. The alert may be in any suitable form, such as in the form of a system-generated text message, e-mail message, or phone message to a particular user or users. For example, the property management system 100 may be configured to send an appropriate alert e-mail to a user if the estimated market value of the user's 1996 Dale Earnhart die-cast matchbox car exceeds $15.00. The user may then use this information, for example, to determine whether to sell the item.

Similarly, the property management system 100 may also be adapted to monitor for the sale of certain items of tangible personal property. For example, a user may wish to purchase a Spider-Man 3 Titanium Die-Cast NIB even though one is not available for immediate purchase. Thus, in one embodiment, the property management system 100 may receive input from the user indicating that he wishes to purchase a Spider-Man 3 Titanium Die-Cast NIB if one becomes available. Thus, in this embodiment, the property management system 100 may identify items being sold via certain websites (e.g., eBay) or to be sold in upcoming auctions. In the event the property management system 100 identifies the item indicated by the user, the property management system 100 can generate an alert to the user indicating that the item is available for purchase. In another embodiment, the property management system 100 can also initiate a purchase request for the item provided, for example, that the cost of the item is below a predetermined value threshold (e.g., below $95.00).

### G. Generation of Certified Valuations

The property management system 100 may also be adapted to generate, or to facilitate the generation of, a certified valuation for a particular item, or portfolio or sub-portfolio of items. In particular embodiments, the property management system 100 may generate this certified valuation using the techniques described above. Alternatively, the property management system 100 may send a request to a human user (e.g., an expert in a particular type of collectable items) to manually produce a certified valuation for the particular item, or portfolio or sub-portfolio of items. The property management system 100 may be further configured to provide the completed certified valuation to the individual requesting the valuation.

A certified valuation may be, for example, in the form of an electronic file that is protected by security features that are applicable to prevent unauthorized modification of the file. The electronic file may include, for example, a description of the item and an estimated market value for the item. The certified valuation may be guaranteed to be accurate by an entity associated with the property management system 100. For example, in one embodiment, the certified appraisal may be used to sell the item via the property management system 100. In another embodiment, the certified appraisal may be transmitted or linked to a third party's website, such as eBay®, where the appraised item may be sold. This may help in assuring potential purchasers of the authenticity and value of the item.

The property management system 100 may also assign a unique valuation identifier to each certified valuation. The unique valuation identifier may then be stored by the property management system 100 in association with the valuation. This enables the property management system 100 to reference and retrieve the valuation as needed. In other words, the property management system 100 may be used to store each generated certified valuation for a given item of tangible personal property 110, sub-portfolio 125, or portfolio 120. Additionally, the property management system 100 may store multiple different valuations for any item of tangible personal property 110, sub-portfolio 125, or portfolio 120.

In addition to generating a certified valuation and assigning a unique identifier to a particular certified valuation, the property management system 100 may transmit the unique valuation identifier and/or other valuation or item information for storage on a Radio Frequency Identification (“RFID”) tag or other portable storage device. The RFID tag (or other portable storage device) storing the unique appraisal identifier and/or other information regarding the item may then be physically attached to the item. The RFID tag may then later be read to retrieve the unique valuation identifier and/or other item information. The retrieved unique valuation identifier may then be used to access, from the property management system 100, the certified valuation and other information regarding the item (e.g., a detailed description of the item, an updated valuation of the item, previous sale dates of the item, or contact information for the owner of the item). In alternative embodiments, this type of information may be stored directly on the RFID tag.

In another embodiment, a portable storage device may (a) be attached to the item and (b) store an audio of file discussing information about the item. For example, a motion-activated storage device may store an audio file that describes the history of the item (e.g., how it was used in the civil war) or an interesting fact about the item (e.g., where and how the item was found). Thus, if the item is on display at a store or museum, for example, the audio file may be adapted to automatically play when the motion sensor is activated.

### H. Location of Particular Items

The property management system 100 may also be used for locating particular items of tangible personal property. In one embodiment, after creating a user account, the user may indicate that the user wishes to locate a particular item of tangible personal property (e.g., an item that an individual recently lost or had stolen, or that the individual wishes to purchase). The property management system 100 may be configured to monitor the item sale information received from the various sale price information providers, or from other sources. When the property management system receives information for an item that is at least similar to the particular item, the property management system 100 may generate an alert to notify the user that an item satisfying the description of the particular item has been located. The property management system 100 may also provide a status of the item (e.g., the item recently sold or is being offered for sale). In one embodiment, this process may be executed by using the universal identifier assigned to each item of tangible personal property. Thus, when item sale information is received for an item of tangible personal property having a universal identifier that corresponds to the universal identifier of a particular item being sought by a particular user, the property management system 100 may generate an alert to the user. In various embodiments, the property management system 100 may generate alerts in response to determining that one or more items have been, or are currently being, sold in a particular class or subclass.

In various embodiments, the property management system 100 may use image recognition technology to identify particular items (e.g., lost or stolen items). For example, the property management system 100 may receive, and compare using image recognition technology: (1) the image of an item of tangible personal property being tracked; and (2) images of items of tangible personal property sold by various sale price information providers. In comparing the images, the property management system 100 determines whether the images match. If the images match or closely resemble one another, the security module may generate and send an alert to one or more particular users as described above.

### I. Use of the System in the Context of Insurance Transactions

Many collectors insure their items of tangible personal property to provide protection in case the items are stolen, lost, or damaged. To insure personal property, the insurer usually needs to assess the risk the insurer would assume by taking on the insurance obligation (e.g., the current market value of the property). It is also beneficial for both the insurer and the insured entity to accurately document the type and quality of items that are insured so that the replacement value of the item can be accurately determined upon loss or damage to the item. Accordingly, insurers may provide a discount to individuals in exchange for the individuals maintaining information regarding their insured items in an electronic database such as those described herein. This may help prevent insurance fraud, and also ensure that an individual maintains sufficient insurance to cover the full replacement value of their items.

### Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for the purposes of limitation.

1. A system for tracking the value of collectibles, the system comprising:
memory; and
one or more processors, wherein the system is configured to:
receive information identifying an item of tangible personal property that is part of a portfolio of collectibles;
identify a universal identifier for the item of tangible personal property, the universal identifier being associated with a taxonomy classifying a plurality of items of tangible personal property into classes;
identify a first condition identifier that at least generally corresponds to the condition of the item of tangible personal property; and
determine an estimated value for the item of tangible personal property, wherein the estimated value is based at least in part on the first condition identifier.

2. The system of claim 1, wherein the system is further configured to:
receive a request for estimated values of the item of tangible personal property, the estimated values spanning an observation period;
identify the estimated values of the item of tangible personal property spanning the observation period; and
generate a graphical representation of the estimated values of the item of tangible personal property spanning the observation period.

3. The system of claim 1, wherein the system is further configured to periodically import, into the system's memory, sale price information for one or more items of tangible personal property associated with the universal identifier.

4. The system of claim 3, wherein the sale price information for the one or more items of tangible personal property associated with the universal identifier comprises one or more sale amounts.

5. The system of claim 4, wherein to determine the estimated value for the item of tangible personal property, the system is further configured to compute an average sale amount from the one or more sale amounts.

6. The system of claim 4, wherein to determine the estimated value for the item of tangible personal property, the system is further configured to:
identify a first sale amount from the one or more sale amounts, wherein the first sale amount is associated with (a) the universal identifier and (b) a second condition identifier that at least generally corresponds to the condition of the item of personal property corresponding to the first sale amount; and
adjust the first sale amount to correspond to the difference in condition represented by the first condition identifier and the second condition identifier.

7. The system of claim 4, wherein to determine the estimated value for the item of tangible personal property, the system is further configured to:
identify outlying sale amounts from the one or more sale amounts; and
compute an average sale amount, excluding the outlying sale amounts, from the one or more sale amounts.

8. The system of claim 4, wherein the system is further configured to periodically re-determine the estimated value for the item of tangible personal property based in part on the sale price information.

9. The system of claim 8, wherein the system is further configured to:
associate a predetermined threshold value with the item of tangible personal property;
determine whether the item of tangible personal property has reached or exceeded the predetermined threshold value; and
in response to determining that the item of tangible personal property has reached or exceeded the predetermined threshold value, generate an alert.

10. The system of claim 1, wherein the system is further configured to:
determine whether the estimated value of the item of tangible personal property has reached or exceeded a predetermined threshold value;
in response to determining that the item of tangible personal property has reached or exceeded the predetermined threshold value, cause display of information indicating that the item of tangible personal property has reached or exceeded the predetermined threshold value; and
in response to determining that the item of tangible personal property has not reached or exceeded the predetermined threshold value, cause display of information indicating that the item of tangible personal property has not reached or exceeded the predetermined threshold value.

11. The system of claim 1, wherein the item of tangible personal property comprises an apparatus storing an audio file discussing the item of tangible personal property.

12. A system for generating appraisals of collectibles, the system comprising:
memory; and
one or more processors, wherein the system is configured to:
identify an item of tangible personal property, wherein the item of tangible personal property comprises a collectible item;
cause display of an offer to provide an appraisal of the item of tangible personal property; and
in response to receiving an acceptance to the offer to provide an appraisal of the item of tangible personal property, initiate an appraisal, wherein to initiate the appraisal, the system is further configured to:
identify a universal identifier for the item of tangible personal property, the universal identifier being associated with a taxonomy classifying a plurality of items of tangible personal property into classes;
identify a condition identifier for the item of tangible personal property that at least generally corresponds to the condition of the item of tangible personal property;
determine an estimated value for the item of tangible personal property, wherein the estimated value is based at least in part on the condition identifier of the item of tangible personal property; and
generate an appraisal, wherein the appraisal is based at least in part on the estimated value of the item of tangible personal property.

13. The system of claim 12, wherein the system is further configured to generate an offer to insure the item of tangible personal property, and wherein an insurance premium associated with the offer to insure the item of tangible personal property is based at least in part on the appraisal.

14. The system of claim 12, wherein the system is further configured to:
assign an appraisal identifier to the appraisal; and
cause transmission of the appraisal identifier to a radio frequency identification (RFID) tag affixed to the item of tangible personal property.

15. A system for identifying collectibles, the system comprising:
memory; and
one or more processors, the system being configured to:
receive a first image of an item of tangible personal property;
identify a class within a taxonomy associated with the item of tangible personal property;
receive a second image of an item from the same class as the item of tangible personal property;
determine whether the first and second images are substantially the same; and
in response to determining that the first and second images are substantially the same, generate an alert.

16. The system of claim 15, wherein the system is further configured to:
determine whether the item of tangible personal property was sold during an observation period; and
in response to determining that the item of tangible personal property was sold during the observation period, generate an alert.

17. A system for tracking collectibles comprising:
memory; and
one or more processors, wherein the system is configured to:
receive input identifying an item of tangible personal property, wherein the item of tangible personal property is a collectible item;
identify a universal identifier for the item of tangible personal property, wherein the universal identifier is associated with a taxonomy classifying a plurality of items of tangible personal property into classes; and
receive information indicating that an item of tangible personal property associated with the universal identifier (a) is available for purchase or (b) has been sold.

18. The system of claim 17, wherein the system is further configured to:
in response to determining that an item of tangible personal property associated with the universal identifier is available for purchase, generate a message indicating that the item of tangible personal property is available for purchase; and
in response to determining that an item of tangible personal property associated with the universal identifier has been sold, generate an alert indicating that the item of tangible personal property may have been located.

19. The system of claim 18, wherein the system is further configured to import sale price information for the item of tangible personal property into the system.

20. The system of claim 17, wherein the system is further configured to:
in response to determining that an item of tangible personal property associated with the universal identifier is available for purchase, generate a message indicating that the item of tangible personal property is available for purchase;
receive a request to purchase the item of tangible personal property; and
initiate a purchase order for the item of tangible personal property.
